(19) United States
(12) Patent Application Publication
(10) Pub. No.: US 2021/0245441 A1
(43) Pub. Date: Aug. 12, 2021

(54) 3D PRINT SERVICE COMPUTE NODE FOR 3D MODEL PRINTING

(71) Applicant: Hewlett-Packard Development Company, L.P., Houston, TX (US)

(72) Inventors: Carlos Alexandre de Araujo Lima, Porto Alegre (BR); Claudio Heckler, Porto Alegre (BR)

(73) Assignee: Hewlett-Packard Development Company, L.P., Spring, TX (US)

(21) Appl. No.: 17/056,061

(22) PCT Filed: Oct. 30, 2018
(86) PCT No.: PCT/US2018/058295

§ 371 Date: Nov. 17, 2020

(51) Int. Cl. B29C 64/393; G06F 3/12; G06Q 20/10; G06Q 20/38; G06Q 20/40; H04L 9/32; B33Y 50/02

(52) U.S. Cl. CPC B29C 64/393; G06F 3/1291; G06Q 20/102; G06Q 20/382; H04L 2209/56; H04L 9/3236; B33Y 50/02; H04L 2209/38; G06Q 20/407

(57) ABSTRACT

A three dimensional (3D) printing system may include a first set of 3D printers, a first print service provider (PSP) compute node in communication with each of the 3D printers of the first set, a second set of 3D printers and a second PSP compute node in communication with each of the 3D printers of the second set. The first PSP compute node and the second PSP compute node each comprise an instance of a block chain electronic ledger and an instance of a smart contract. The smart contract is to: automatically compare received funds for a selected 3D model, automatically refund the funds in response to the received funds being inadequate, automatically trigger printing of the selected three-dimensional model in response to the received funds being adequate and automatically refund the funds in response to failure to complete printing.

### BACKGROUND

Three-dimensional (3D) printers are used to form 3D objects based upon digital representations provided by 3D models. Low volume printing of three-dimensional objects is often complicated, expensive and inefficient.

### BRIEF DESCRIPTION OF THE DRAWINGS

FIG. 1 is a block diagram schematically illustrating portions of an example 3D printing system.

FIG. 2 is a block diagram schematically illustrating portions of an example print service provider compute node instructions for use in the system of FIG. 1.

FIG. 3 is a flow diagram of an example 3D printing method.

FIG. 4 is a diagram illustrating operation of the example 3D printing system of FIG. 1 in a larger example 3D printing system environment.

FIG. 5 is a flow diagram of an example 3D printing method.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed herein are example 3D printing systems, computer-implemented 3D printing methods and computer 3D printing instructions that facilitate economical and efficient printing of three-dimensional objects, whether in low volumes or high volumes. Disclosed herein are example 3D printing systems, computer-implemented 3D printing methods and computer 3D printing instructions that facilitate the use of fleets of three-dimensional printers to automatically carry out 3D printing tasks or jobs received through network communications with less management and overhead costs. The example 3D printing systems, computer-implemented 3D printing methods and computer 3D printing instructions may automatically address issues such as 3D model selection, customer purchases, designer or IP holder payments, copyrights and/or piracy.

The example 3D printing systems, computer-implemented 3D printing methods and computer 3D printing instructions utilize multiple fleets or sets of 3D printers with a centralized print service provider (PSP) compute node managing each of the fleets. For purposes of this disclosure, a compute node is a system or device connected to a network, wherein each device has a network address , such as a MAC address which uniquely identifies a device. Each PSP compute node may utilize a block chain electronic ledger in combination with smart contract software automatically assign and manage requested 3D printing projects and automatically carry out financial transactions with respect to the 3D printing projects. As a result, low volume 3D printing projects may be efficiently provided to a wider spectrum of users. The 3D printing project efficiency provided by the 3D printer print service provider compute node that manages the fleets of 3D printers further facilitate high-volume 3D printing tasks.

An example three dimensional (3D) printing system may include a first set of 3D printers, a first print service provider (PSP) compute node in communication with each of the 3D printers of the first set node, a second set of 3D printers and a second PSP compute node in communication with each of the 3D printers of the second set The first PSP compute node and the second PSP compute node each comprise an instance of a block chain electronic ledger and an instance of a smart contract. The smart contract of each of the first PSP compute node and the second PSP compute node is to: automatically compare received funds for a selected 3D model, automatically refund the funds in response to the received funds being inadequate for the selected 3D model, automatically trigger printing of the selected three-dimensional model in response to the received funds being adequate for the selected 3D model and automatically refund the funds in response to signals indicating failure to complete printing of the 3D model.

A computer-implemented method may include receiving, with a print service provider (PSP) compute node, a request to print a three-dimensional (3D) model, and automatically activating a smart contract in response to receiving the request. The activated smart contract may automatically compare received funds for the 3D model, automatically trigger printing of the selected three-dimensional model by a 3D printer of a set of 3D printers serviced by the PSP compute node in response to the received funds being adequate for the selected 3D model and automatically refund the funds in response to signals indicating failure to complete printing of the 3D model.

A non-transitory computer-readable medium may contain instructions for directing a processor. The instructions may include funds confirmation instructions to direct the processor of a print service provider compute node to confirm adequacy of funds for printing of a selected three-dimensional (3D) model, print completion instructions to trigger printing of the selected 3D model, refund instructions to direct the processor to refund held funds in response to inadequate funds for printing of the selected 3D model, refund instructions to direct the processor to refund held funds in response to a failure to print the selected 3D model by a printer and fund transfer instructions to direct the processor to transfer held funds to a predetermined destination in response to completion of the selected 3D model by the printer.

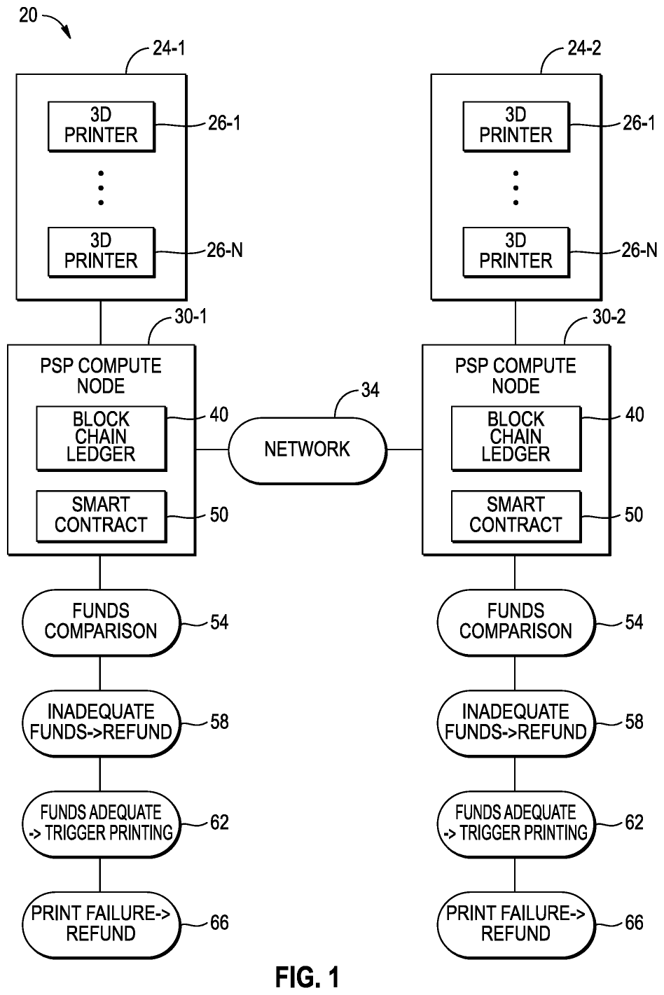

FIG. 1 is a block diagram schematically illustrating portions of an example 3D printing system 20. 3D printing system 20 uses sets or fleets of three-dimensional printers to automatically carry out individual and low volume 3D printing tasks received through network communications with less management and overhead costs. 3D printing system 20 automatically addresses issues such as 3D model selection, customer purchases and project completion verification. 3D printing system 20 utilizes multiple fleets or sets of 3D printers with centralized print service provider (PSP) compute nodes managing respective fleets. Each PSP compute node may utilize a distributed or block chain electronic ledger in combination with smart contract software automatically assign and manage requested 3D printing projects and automatically carry out financial transactions with respect to the 3D printing projects.

The distributed block chain electronic ledger involves list of records, called blocks, which are linked using cryptography. Each block may include a cryptographic hash of the previous block, a timestamp and transaction data, sometimes represented as a Merkel tree root hash. Such block chains are resistant to modification of the data and provide an open distributed ledger that can record transactions between two parties in an efficient and verifiable manner. Such a block chain may be managed in a peer-to a computer network. Adhering to protocol for internode communication and the validation of new blocks. Once recorded, data in any given block cannot be altered retroactively without alteration of all subsequent blocks which demand consensus of the network majority.

The smart contract is a self-executing contract with terms of an agreement between two parties being directly written into lines of code. The code an agreement contained therein may exist across a distributed, decentralized block chain network. The smart contract permits trusted transactions agreement to be carried out among disparate, anonymous parties without a central authority, legal system or external enforcement mechanism. Such a smart contract may render transactions traceable, transparent and irreversible.

Through the combined use of a block chain distributed ledger and a smart contract, low volume 3D printing projects may be efficiently provided to a wider spectrum of users. The 3D printing project efficiency provided by the 3D printer print service provider compute node that manages the fleets of 3D printers further facilitate high-volume 3D printing tasks. 3D printing system 20 comprises fleets or sets 24-1, 24-2 of 3D printers 26-1 . . . 26-n (collectively referred to as printers 26), and print service provider (PSP) compute nodes 30-1, 30-2 (collectively referred to as nodes 30) connected by a network 34.

Sets 24 of 3D printers 26 each comprise a fleet of multiple distinct 3D printers 26. Each 3D printer 26 is to carry out the printing of a three-dimensional object or article in accordance with the provided 3D digital model of the object or article. Each set 24 may comprise different types of 3D printers, wherein each different type may have unique properties or attributes. For example, one of the printers 26 may be capable of printing larger 3D objects as compared to the other 3D printers of the set. One of the printers 26 may be capable of providing higher resolution or more intricate printing of a 3D object as compared to other 3D printers of the set. One of the printers 26 may be capable of printing with different build materials or with other 3D printing consumables such as different binder agents or different interface layer materials. In some implementations, each of the sets 24 may perform 3D printing using different processes. For example, one of the printers may use a powder bed and binding agents whereas it another one of the printers may directly jet and the printing build material itself in the form of a 3D object or article. In some implementations, each of sets 24 may consist of a homogenous group of 3D printers, wherein one of the sets 24 has a first characteristic or type of 3D printers and the other of sets 24 has a second different characteristic or type of 3D printers.

PSP compute nodes 30 are each connected to each of the 3D printers 26 of their respective fleets or sets 24. Each of PSP compute nodes 30 receives 3D print job requests and, based upon current usage of the printers 26 in the respective fleet as well as the characteristics of the 3D print job, selects one of the printers 26 in its managed set 24-1, 24-2 for receiving the 3D print job request in for carrying out the 3D print job request. Each of the PSP compute nodes 30 further carries out processing of the transactional tasks relating to the 3D print job request. Each PSP compute node 30 comprises a block chain ledger 40 and a smart contract 50.

Block chain ledger 40 is part of a distributed electronic ledger that facilitate secure distribution of digital files in a computing network formed by the multiple PSP compute nodes 30 of system 20. In one implementation, a request for a 3D print job may be submitted to the electronic ledger formed by the block chain ledger's 40 of system 20. The print job request may identify a file or model to be printed, identification of the requester and the like, wherein the print job request is posted on the ledger whereby the request is transparent to each of the PSP compute nodes 30 in system 20 and that maintain the ledger. The request may additionally include metadata that describe the contents of the request in the set of conditions for executing or accepting the request. When a requester accepts a print job request that has been posted to the electronic ledger, activities toward completion of the print job request may recorded in the ledger and validated by all or some of the other PSP compute nodes 30 of system 20. Each request may be with a code for smart contract 50 which is executed responsive to a particular PSP compute node 30 accepting the print job request.

Smart contract 50 comprises a computer application or program stored at each PSP compute node 30 within the block chain ledger 40. Smart contract 50 automatically executes transactions related to the print job request. Such transactions may be automatically carried out by smart contract 50. In one implementation, each smart contract 50 stored as part of the ledger 40 in its associated node 30 carries out a funds comparison as indicated by transaction block 54. Such “funds comparison” may include a comparison of the funds of the print job requester or user that are available for debiting to the cost for the selected 3D print job. For example, in one implementation, smart contract 50 may include instructions to direct a processor to ascertain the cost of a selected print job, possibly including the cost for royalty or other licensing cost for use of the 3D print model, the charge for use of the particular 3D printer 26, shipment costs and the like. Such instruction may further direct the processor to then compare the received funds from the 3D print job requester to the estimated cost.

As indicated by transaction block 58, if such funds comparison identifies inadequate funds being paid or set aside for the requested 3D print job, smart contract 50 may automatically terminate the processing of the request and refund any funds received at such time. Alternatively, as indicated by transaction block 62, in response to the funds paid or set aside being adequate for the requested 3D print job, smart contract 50 may automatically trigger the initiation of the 3D print job. Such triggering may result in the block chain ledger 40 recording the acceptance of the 3D print job in the electronic ledger. Such triggering may result in the compute node 30 selecting the 3D printer 26 out of the respective set 24 to carry out the print job. Such triggering may result in the smart contract 50 further receiving the 3D model and decrypting the 3D model for execution of the 3D print job.

During execution of the 3D print job, the smart contract 50 may monitor the status. Upon completion of the 3D print job, smart contract 50 may automatically debit the received funds to carry out further financial transaction such as payment of any license/royalty fees to the owner of the 3D model and/or its rights, payment of the owner or proprietor of the 3D printer and in service provider and the like. Smart contract which may further arrange shipping of the produced 3D product to the print job requester or its designated recipient. As indicated by transactional block 66, in response to the 3D print job failing, the 3D printer being unable to complete the print job, the smart contract 50 may automatically output electronic messages causing the received funds to be refunded to the print job requester.

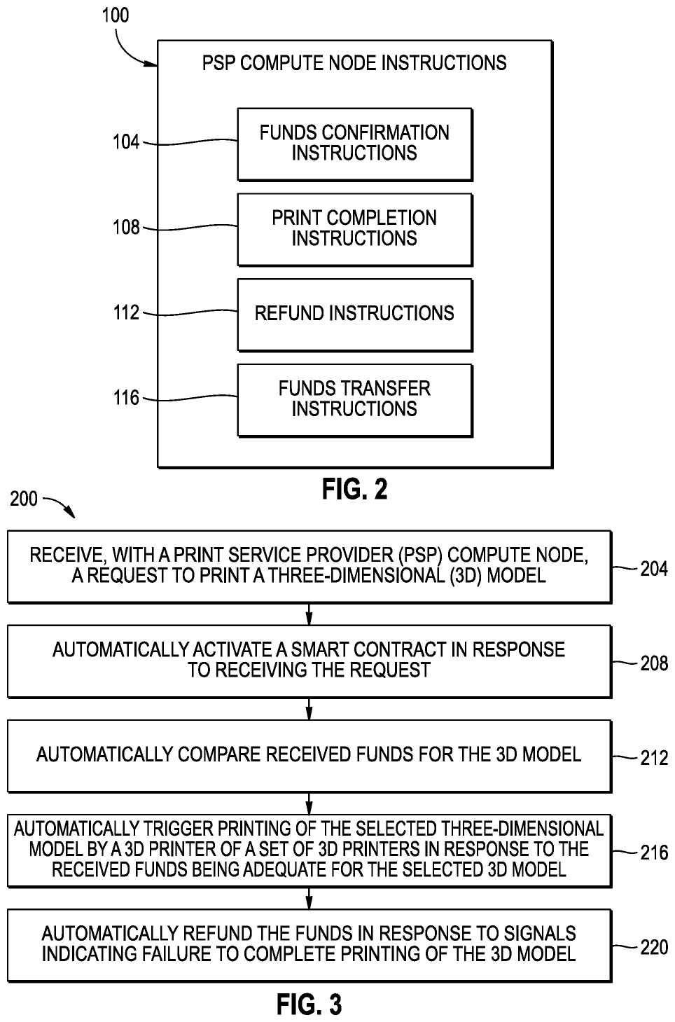

FIG. 2 is a block diagram illustrating example PSP compute node instructions 100 that are part of this smart contract 50 of system 20. Such instructions direct a processor to automatically carry out various transactions associated with a print job or task request. Such compute node instructions comprise funds confirmation instructions 104, print completion instructions 108, refund instructions 112 and funds transfer instructions 116.

Funds confirmation instructions 104 carry out the funds comparison identified by transaction block 54 above. Such instructions 104 direct a processor to carry out a comparison of the funds of the print job requester or user that have been received or paid by the requester for the selected 3D print job to the amounts set for the 3D print job being requested. For example, in one implementation, instructions 104 may direct a processor to ascertain the cost of a selected print job, possibly including the cost for royalty or other licensing cost for use of the 3D print model, the charge for use of the particular 3D printer 26, shipment costs, material costs and the like. The received funds are compared to this cost or to a predetermined charge amount.

Print completion instructions 108 direct the processor to monitor the status of the particular 3D print job. In one implementation, such instructions may direct the particular PSP compute node 30 to output status messages to the 3D print job requester. Such instructions may further direct the processor to manage the execution of the 3D print job. For example, such instructions 108 may direct the processor in the selection of the particular 3D printer of the associated set 24 for executing the print job. Such instructions 108 may direct the processor to receive and decrypt the 3D model to be printed as part of the 3D print job and to forward the decrypted 3D model to the selected 3D printer for printing. Such instructions 108 may verify appropriate copyright ownership or authorization for use of the selected 3D model in the 3D print job request. Such instructions 108 may direct the processor to consult the electronic ledger and the print job request so as to satisfy any restrictions placed on the 3D print job. For example, such instructions may direct the processor to verify copyright ownership of the selected 3D model to be printed and to automatically limit the number of prints or copies made from the decrypted 3D model. Instructions 108 may direct the processor to track the number of 3D copies or prints made and to automatically inhibit use of the 3D model beyond the prescribed number of 3D prints.

Refund instructions 112 direct the processor to automatically carry out the refunding of funds to the 3D print job requester. Such instructions 112 may direct the processor to automatically refund funds, such as electronic funds, to the print job requester in response to a determination that the received funds are inadequate for the requested 3D print job, prior to initiation of the requested 3D print job. Such instruction 11 12 may direct the processor to automatically refund in response to a print failure, wherein the designated printers 26 of the set 24 cannot complete the requested 3D print job and/or wherein an alternative printer 26 could not carry out the 3D print job request.

Funds transfer instructions 116 direct the processor to automatically transfer funds upon verified completion of a 3D print job. Such fund transfer instructions 116 may direct the processor to automatically transfer a portion of the funds received from the 3D print job requester to various entitled parties or providers. For example, fund transfer instructions 116 may direct the processor to electronically transfer a portion of funds received from the 3D print job requester to an owner of rights, such as intellectual property rights or license rights. Fund transfer instruction 116 may further direct the processor to electronically transfer a portion of funds received from the 3D print job requester to the owner of the print service provider and its fleet or set of 3D printers.

FIG. 3 is a flow diagram of portions of an example computer-implemented 3D printing method 200. Method 200 facilitate the use of fleets of three-dimensional printers to automatically carry out individual and low volume 3D printing tasks received through network communications with less management and overhead costs. Method 200 may automatically address issues such as 3D model selection, customer purchases, designer or IP holder payments, unauthorized copies or printing, copyrights and/or piracy. Method 200 utilizes multiple fleets or sets of 3D printers with a centralized print service provider (PSP) compute node managing each of the fleets. Each PSP compute node may utilize a block chain electronic ledger in combination with smart contract software automatically assign and manage requested 3D printing projects and automatically carry out financial transactions with respect to the 3D printing projects. As a result, low volume 3D printing projects may be efficiently provided to a wider spectrum of users. The 3D printing project efficiency provided by the 3D printer print service provider compute node that manages the fleets of 3D printers further facilitate high-volume 3D printing tasks.

As indicated by block 204, PSP compute node, such as one of compute nodes 30 described above, receives a request to print a 3D model. In some implementations, the request is posted to an electronic ledger, such as a block chain ledger. As indicated by block 208, the PSP compute node automatically activates a smart contract in response to receiving the request. The smart contract comprises a computer application or program stored at the PSP compute node within a block chain ledger. The smart contract automatically executes transactions related to the print job request. Such transactions may be automatically carried out by the smart contract.

As indicated by block 212, the smart contract of the PSP compute node automatically compares funds received from the print job requester for the 3D model to be printed. Such “funds comparison” may include a comparison of the funds of the print job requester or user that are available for debiting to the cost for the selected 3D print job. For example, in one implementation, the smart contract may ascertain the cost of a selected print job, possibly including the cost for royalty or other licensing cost for use of the 3D print model, the charge for use of the particular 3D printer 26, shipment costs and the like. The smart contract may further direct the processor to then compare the received funds from the 3D print job requester to the estimated cost.

As indicated by block 216, the smart contract may automatically trigger the initiation of the 3D print job. Such triggering may result in the block chain ledger recording the acceptance of the 3D print job in the electronic ledger. Such triggering may result in the PSP compute node selecting the 3D printer out of the respective set to carry out the print job. Such triggering may result in the smart contract further receiving the 3D model and decrypting the 3D model for execution of the 3D print job.

In some implementations, the smart contract may automatically monitor the status of the 3D print job once triggered. As indicated by block 220, upon failure to complete printing of the 3D model, the smart contract may automatically initiate the transfer or refund of the funds previously received from the 3D print job requester. In some implementations, upon completion of 3D print job, the smart contract may automatically initiate the transfer of selected portions of the funds received from the 3D print job requester to recipient parties or destinations such as owner of rights to the 3D model and the provider of the 3D print job services.

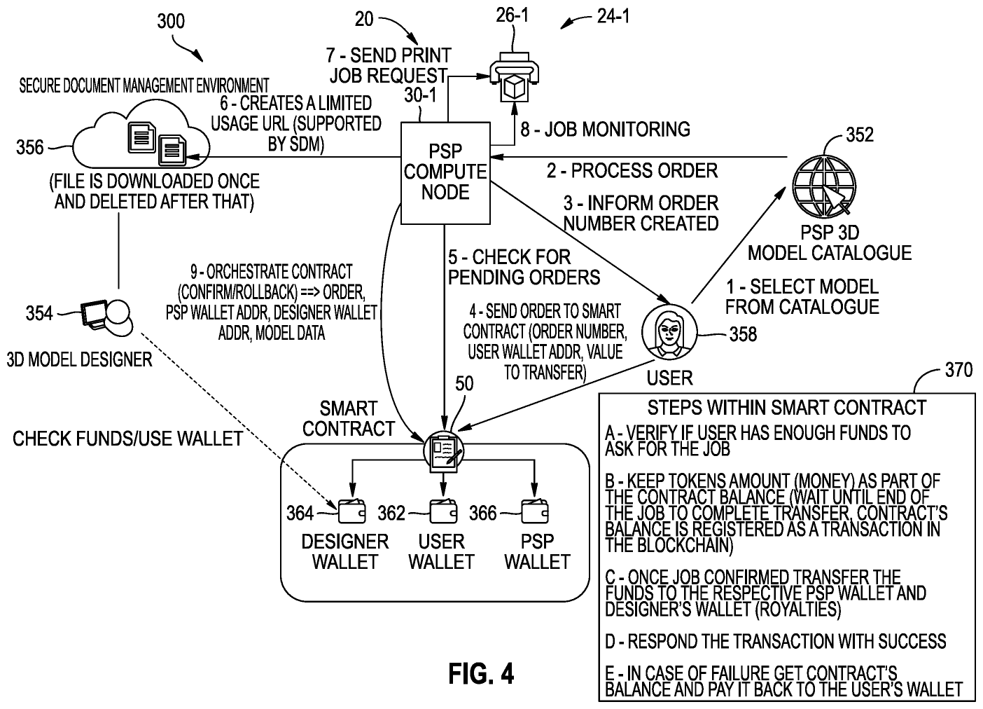

FIG. 4 is a diagram illustrating 3D printing system 20 operating in a larger 3D printing environment 300. For ease of illustration, a portion of 3D printing system 20 is illustrated in FIG. 4. 3D printing system 20 may include PSP compute node instructions similar to instructions 100 described above and may carry out method 200 described above. As described above, system 20 uses sets or fleets of three-dimensional printers (one fleet or set of printers being schematically shown a single printer icon) to automatically carry out individual and low volume 3D printing tasks received through network communications with less management and overhead costs. 3D printing system 20 automatically addresses issues such as 3D model selection, customer purchases and project completion verification. 3D printing system 320 utilizes multiple fleets or sets of 3D printers with a centralized print service provider (PSP) compute node for each set of printers, each PSP compute node managing its respective set. Each PSP compute node may utilize a block chain electronic ledger in combination with smart contract software automatically assign and manage requested 3D printing projects and automatically carry out financial transactions with respect to the 3D printing projects. As a result, low volume 3D printing projects may be efficiently provided to a wider spectrum of users. The 3D printing project efficiency provided by the 3D printer print service provider compute node that manages the fleets of 3D printers further facilitate high-volume 3D printing tasks. As shown by FIG. 4, in addition to system 20, environment 300 comprises a PSP 3D model catalog 352, a 3D model designer 354, a secure document management environment 356 and a user 358.

FIG. 4 further illustrates one example 3D printing job being processed in an example manner by system 20 in environment 300. It should be appreciated that 3D printing process may be executed by system 20 in environment 300 and other fashions as well. As indicated by transaction 1, the user 358 may select a 3D model for printing from the catalog 352. Catalog 352 may be maintained on a website or webpage. Through such a webpage, the user 358 may make the selection. As indicated by transaction 2, the website processes the order and sends the order to the PSP compute node 30. As indicated by transaction 3, PSP compute node 30-1 then informs user 358 that the order number has been created. As indicated by attractions action 4, upon receiving indications in order number has been created, user 35 a uses the order number to send the order to smart contract 50 of compute node 30-1. The order includes the received order number, the address of the user wallet 362 and the value or amount of the funds to transfer from the user wallet.

As indicated by transaction 5, upon receiving the order from user 358, the smart contract 50 checks for pending orders being executed by compute node 30-1. If pending orders are in process, the order may be temporarily queued until PSP communal 30-1 is available to execute the print order with sets 24-1 of its printers 26. As indicated by transaction 6, upon availability, PSP compute node 30-1 creates a limited usage uniform resource locator (URL) which is supported by SDM in one implementation. The limited usage URL is transmitted to the secure document management environment 356 which downloads the selected 3D model from the 3D model designer 354. The model is downloaded once and deleted after that, inhibiting unauthorized copies.

As indicated by transaction 7, upon receiving this 3D model, PSP compute node 30-1 sends a print job request to a selected one of printers 26 of set 24. As described above, PSP compute node 30-1 may select one of the printers 26 for the particular 3D print job based upon current usage of the printers 26 in the respective fleet as well as the characteristics of the 3D print job. For example, one of the printers 26 may be capable of printing larger 3D objects as compared to the other 3D printers of the set. One of the printers 26 may be capable of providing higher resolution or more intricate printing of a 3D object as compared to other 3D printers of the set. One of the printers 26 may be capable of printing with different build materials or with other 3D printing consumables such as different binder agents or different interface layer materials. In some implementations, each of the sets 24 may perform 3D printing using different processes. For example, one of the printers may use a powder bed and binding agents whereas it another one of the printers may directly jet and the printing build material itself in the form of a 3D object or article. In some implementations, each of sets 24 may consist of a homogenous group of 3D printers, wherein one of the sets 24 has a first characteristic or type of 3D printers and the other of sets 24 has a second different characteristic or type of 3D printers.

As indicated by transaction 8, PSP compute node 30-1 triggers printing and monitors execution of the 3D print job. Such triggering may result in the smart contract 50 further receiving the 3D model and decrypting the 3D model for execution of the 3D print job.

As indicated by transaction 9, upon completion of the 3D print job, smart contract 50 orchestrates completion of the contract by transferring those fronds from the user wallet 362 (the funds set aside or escrow by using 358 for the 3D print job) to the account or “designer wallet” 364 of the 3D model designer 354 into the financial account or “PSP wallet” 366 of the print service provider which provides sets 24 of printers 26.

As indicated by block 370, during handling of the 3D print job request, the smart contract 50 carries out various steps. The smart contract 50 verifies if the user 358 has enough funds deposited in the user wallet 362 to requester asked for a particular 3D print job (using instructions 104 and per block 212 described above). Smart contract 50 keeps the payment as part of the contract balance, wherein smart contract 50 waits until the end of the project to complete transfer to register the contract balance as a transaction in the block chain ledger 40 (shown in FIG. 1). As noted above, once the print job has been completed, smart contract 50 confirms the transfer of the funds to the PSP wallet 366 and the designer's wallet 364. Such payment to the designer's wallet may be in the form of royalties. Lastly, smart contract 50 responds to the user 358 indicating success of the print job request and transaction. In circumstances where the print job is unable to be completed, smart contract 50 obtains the contract balance and refunds it back to the user's wallet 362.

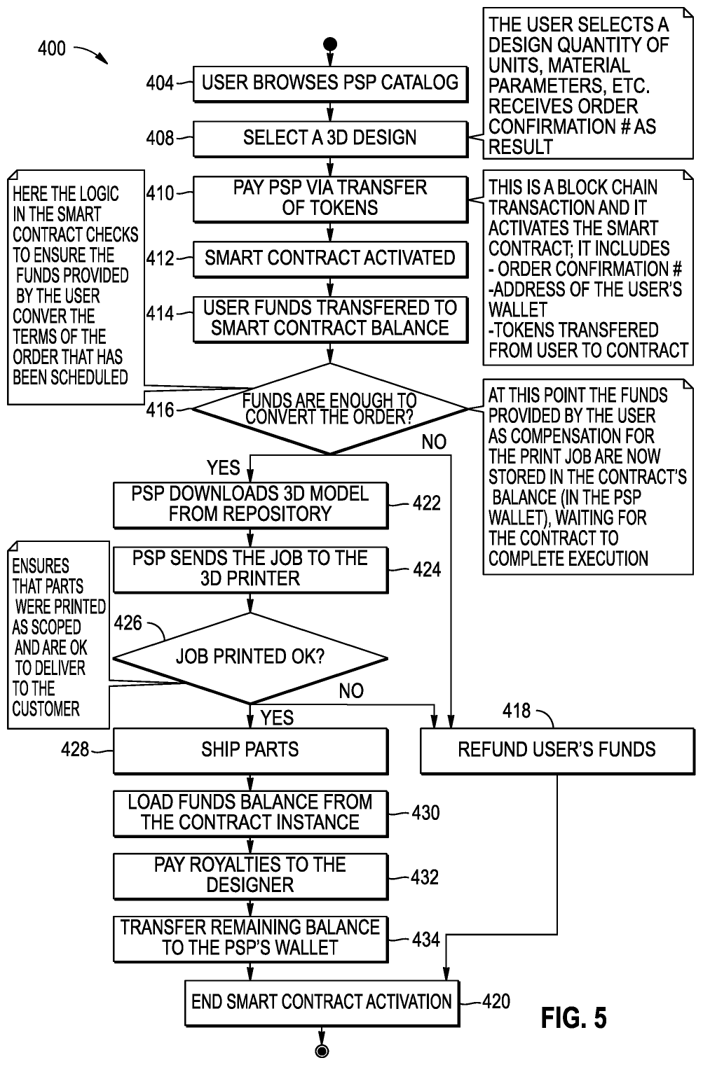

FIG. 5 is a flow diagram of an example 3D printing method 400. Method 400 is described in the context of being carried out by system 20 in environment 300 shown and described above with respect to FIG. 4. It should be appreciated that method 400 may likewise be carried out with other 3D printing systems in the same or other 3D printing environments.

As indicated by block 404, a user/job requester browses a PSP catalog comes such as model catalogers 352. As indicated by block 408, the job requester selects a 3D design. Such a selection may involve the quantity of units, material parameters and the like. In response to selecting design, the user receives an order confirmation number.

As indicated by block 410, the print service provider is paid through the transfer of tokens or credits. This transfer includes the order confirmation number received in block 408, and address of the user's wallet 362 and the amount of tokens, funds to be transferred from the user to the contract.

The transfer of tokens triggers or activates a smart contract as indicated by block 412. The activation of the smart contract involves a call being made to a smart contract that receives information regarding the amount to be transferred, the address that is to receive the amount, the wallet that is going to see the value, the uniform resource locator where the model is located within the secure document management (SDM) service and the preorder identification: the job identified for the preestablished parameters for the print run which was supplied by the PSP compute node 30-1 when the initial agreement was made.

As indicated by block 414, smart contract 50 transfers user funds corresponding to the tokens from the user to the contract. Such funds may be transferred to the PSP wallet 366, where they await completion of the contract and the print job.

As indicated by block 416, the smart contract 50 determines whether the funds deposited in the PSP while 366 from the user wallet 362 are sufficient to cover the costs of the order. As indicated by block 418, if the funds are insufficient, the funds previously transferred to the PSP wallet 366 are refunded back to the user wallet 362 and the smart contract activation is ended as indicated by block 420.

As indicated by block 422, if the funds are sufficient, PSP compute node 30-1 downloads a 3D model from the repository. In one implementation, the 3D models may have been deposited in the repository by the 3D model designer 354. Such a process may involve the model be encrypted with a PSP provided key into a storage service 356 suitable for large binary content such as 3D models, such as the HP Secure Document Management (SCM) service or other document storage services. The PSP compute node further sets and expiration for the job file, configuring the STM to deleted after a given period to thereby add another security layer to the process.

As indicated by block 424, once a model has been downloaded and decrypted, the PSP compute node 30-1 sends a job to a selected 3D printer. As indicated by block 426, the PSP compute node 30-1 continues to monitor the execution of the print job to ensure that all the parts were printed as scoped in arcade to deliver to the customer/user 358. As indicated by block 428, once a proxy is complete, the smart contract authorizes and initiates the shipment of the completed 3D products or parts to the user 358 or its designated recipient.

As indicated by block 430, the smart contract 50 loads the fund balances from the contract instance, the PSP while 366 and pays royalty funds to the 3D model designer 354 per block 432. The remaining balance is transferred are maintained in the PSP while 366 per block 434. Thereafter, particular contract is terminated as indicated by block 420.

Although the present disclosure has been described with reference to example implementations, workers skilled in the art will recognize that changes may be made in form and detail without departing from the scope of the claimed subject matter. For example, although different example implementations may have been described as including features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A three dimensional (3D) printing system comprising:
a first set of 3D printers;
a first print service provider (PSP) compute node in communication with each of the 3D printers of the first set node;
a second set of 3D printers;
a second PSP compute node in communication with each of the 3D printers of the second set, wherein the first PSP compute node and the second PSP compute node each comprise an instance of a block chain electronic ledger and an instance of a smart contract, wherein the smart contract of each of the first PSP compute node and the second PSP compute node is to:
automatically compare received funds for a selected 3D model;
automatically refund the funds in response to the received funds being inadequate for the selected 3D model;
automatically trigger printing of the selected three-dimensional model in response to the received funds being adequate for the selected 3D model; and
automatically refund the funds in response to signals

2. The 3D printing system of claim 1, wherein the smart contract is to further:
automatically transfer a portion of the received funds to an owner of rights to the 3D model.

3. The 3D printing system of claim 1, wherein the smart contract is to further:
transfer a portion of the received funds to a selected account in response to signals indicating printing completion of the 3D model.

4. The 3D printing system of claim 1, wherein the PSP compute node is to download the selected 3D model from a model repository in response to the smart contract of the PSP compute node indicating adequacy of the received funds for the selected 3D model.

5. A computer-implemented method comprising:
receiving, with a print service provider (PSP) compute node, a request to print a three-dimensional (3D) model;
automatically activating a smart contract in response to receiving the request, wherein the smart contract:
automatically compares received funds for the 3D model;
automatically triggers printing of the selected three-dimensional model by a 3D printer of a set of 3D printers serviced by the PSP compute node in response to the received funds being adequate for the selected 3D model; and
automatically refunds the funds in response to signals indicating failure to complete printing of the 3D model.

6. The method of claim 5 further comprising:
downloading the 3D model from a 3D model repository, wherein the 3D model is encrypted; and
decrypting the 3D model.

7. The method of claim 5 further comprising automatically transferring a portion of the received funds to an owner of rights to the 3D model.

8. The method of claim 5 further comprising automatically transferring a portion of the received funds to a selected account in response to signals indicating printing completion of the 3D model.

9. The method of claim 5 further comprising accessing an electronic ledger that identifies a plurality of 3D model files that have been made available for distribution, wherein the electronic ledger comprises a blockchain, wherein respective instances of the electronic ledger are separately maintained by each of a plurality of print service provider (PSP) compute nodes including the PSP compute node.

10. The method of claim 5 further comprising recording each transaction at the PSP compute node at a second PSP compute node servicing a second set of three-dimensional printers.

11. A non-transitory computer-readable medium containing instructions for directing a processor, the instructions comprising:
funds confirmation instructions to direct the processor of a print service provider compute node to confirm adequacy of funds for printing of a selected three-dimensional (3D) model;
print completion instructions to trigger printing of the selected 3D model;
refund instructions to direct the processor to refund held funds in response to inadequate funds for printing of the selected 3D model;
refund instructions to direct the processor to refund held funds in response to a failure to print the selected 3D model by a printer; and
fund transfer instructions to direct the processor to transfer held funds to a predetermined destination in response to completion of the selected 3D model by the printer.

12. The medium of claim 11, wherein the instructions further comprise:
block chain instructions to transmit transaction results of a print service provider (PSP) compute node servicing the printer to a second PSP compute node servicing a second printer.

13. The medium of claim 11, wherein the instructions further comprise:
fund transmission instructions to automatically transmit a portion of the funds to an account of an owner of rights to the selected 3D model in response to completion of printing of the 3D model by the printer.

14. The medium of claim 11, wherein the instructions further comprise:
downloading instructions to automatically download the selected 3D model from a remote 3D model repository in response to a

15. The medium of claim 11, wherein the instructions further comprise:
printer selection and control instructions to the printer, from a set of printers, and to transmit the 3D model to printer.
